(19) United States
(12) Patent Application Publication
(10) Pub. No.: US 2002/0044985 A1
(43) Pub. Date: Apr. 18, 2002

(54) Powder pressing method and device

(76) Inventors: Peter Nordell, Goteborg (SE); Jonas Malmqvist, Molndal (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/977,993

(22) Filed: Oct. 17, 2001

(30) Foreign Application Priority Data
Oct. 17, 2000 (SE) 0003755-6

(51) Int. Cl. B22F 3/03; B29C 43/36

(52) U.S. Cl. 425/352

(57) ABSTRACT

A powder pressing device includes a die having an inner space forming a pressing region in which powder pressing takes place, and upper and lower plungers moveable into and out of the inner space of the die. The die has an ejecting region possessing an inlet proximal to the pressing region and an outlet distal from the pressing region. The dimension of the die gradually decreases in the ejecting region of the die in a direction from its inlet to its outlet.

This application is based on and claims priority under 35 U.S.C. § 119 with respect to Swedish Application No. 0003755-6 filed on Oct. 17, 2000, the entire content of which is incorporated herein by reference.

### FIELD OF THE INVENTION

The present invention generally relates to a pressing device. More particularly, the present invention pertains to a powder pressing device having a die possessing an inner space provided with a pressing region, in which powder pressing takes place, and an upper and lower plunger movable into and out of the inner space of the die.

### BACKGROUND OF THE INVENTION

FIG. 1 illustrates a powder pressing operation carried out in a known powder pressing device. The powder is disposed in a pressing cavity defined by the inner space of a hard metal insert A and the respective upper and lower surfaces of a lower B and upper plunger C fitted into the inner space. The metal insert A has an outer conical surface fitted into an inner conical space of a die D. Typically, a pressing force F of about 36 tons is used, with the pressure f on the inner walls of the metal insert then being about 1900 Mpa. The pressing step of the powder pressing operation is schematically illustrated in FIG. 1a. In FIG. 1b the residual tension in the body E accomplished by the pressing operation is illustrated by the arrows r. The residual tension is often larger than 400 Mpa. This residual tension creates a problem when the body E is ejected out of the inner space of the metal insert. As schematically shown in FIG. 1(c), the body E is influenced by shear forces when the body E comes into contact with the sharp lower edge of the metal insert at the same time as the residual tension in the body is abruptly released. These shear forces can lead to an uncontrollable breaking or cracking of the body E.

A need thus exists for a powder pressing device in which the risk associated with breaking or cracking of the press-formed body due to residual tension is significantly reduced or substantially eliminated.

### SUMMARY OF THE INVENTION

A powder pressing device includes a die having an inner space forming a pressing region in which powder pressing takes place, and upper and lower plungers moveable into and out of the inner space of the die. The die has an ejecting region possessing an inlet proximal to the pressing region and an outlet distal from the pressing region. The dimension of the die gradually decreases in the ejecting region of the die in a direction from its inlet to its outlet.

With this construction of the ejecting region of the die, the stiffness of the die gradually decreases in the direction of the ejection, thereby allowing the compacted body to gradually release its residual tension so that the residual tension in the compact body at the outlet of the die has been reduced to such an extent that the shear stresses in the outlet will not be so large as to cause damage to the compact.

In a preferred form, the die has a funnel-like shape in the ejecting region and a hard metal tube extends through the pressing and ejecting regions of the die. The metal tube is press-fitted to the inner wall of the tubular hard metal insert in the pressing region and to the inner wall of the die in the ejecting region. The hard metal tube provides for a smooth transition between the pressing region and the ejecting region of the die.

The hard metal tube preferably extends beyond the outlet end of the ejecting region and the wall of the hard metal tube has a decreased thickness in the end portion of the metal tube. Also, a tubular insert can be disposed in the pressing region of the die and press-fitted into the inner space of the die in the region.

According to another aspect of the invention, a powder pressing device includes a die having an inner space, a metal insert positioned in the inner space of the die and having a bore defining a pressing region in which powder pressing takes place, an upper plunger movable into and out of the inner space, and a lower plunger movable into and out of the inner space. A tubular body is provided at one end of the pressing region and has an interior defining an ejecting region. The inlet of the ejecting region is located proximal the pressing region and the outlet of the ejecting region is distal from the pressing region. The body has a wall which possesses a thickness adjacent the outlet that is less than the thickness of the wall adjacent the inlet.

In accordance with another aspect of the invention, a powder pressing device includes a die having an inner space in which is defined a pressing region that receives powder for powder pressing to produce a compact, an upper plunger movable into and out of the inner space and a lower plunger movable into and out of the inner space to powder press the powder and form the compact. The die includes a tubular body forming an ejecting region having an inlet proximal to the pressing region and an outlet distal from the pressing region. The tubular body has a stiffness that gradually decreases in the direction towards the outlet of the ejecting region to allow the compact to gradually release its residual tension during ejection of the compact.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIGS. 1(a)-1(c) schematically illustrate a known powder pressing operation.

FIGS. 2(a) and 2(b) schematically illustrate, by way of a cross-sectional view, a powder pressing operation in a device according to a first embodiment of the present invention.

FIG. 3 schematically illustrates, by way of a cross-sectional view, a powder pressing device according to a second preferred embodiment of the invention.

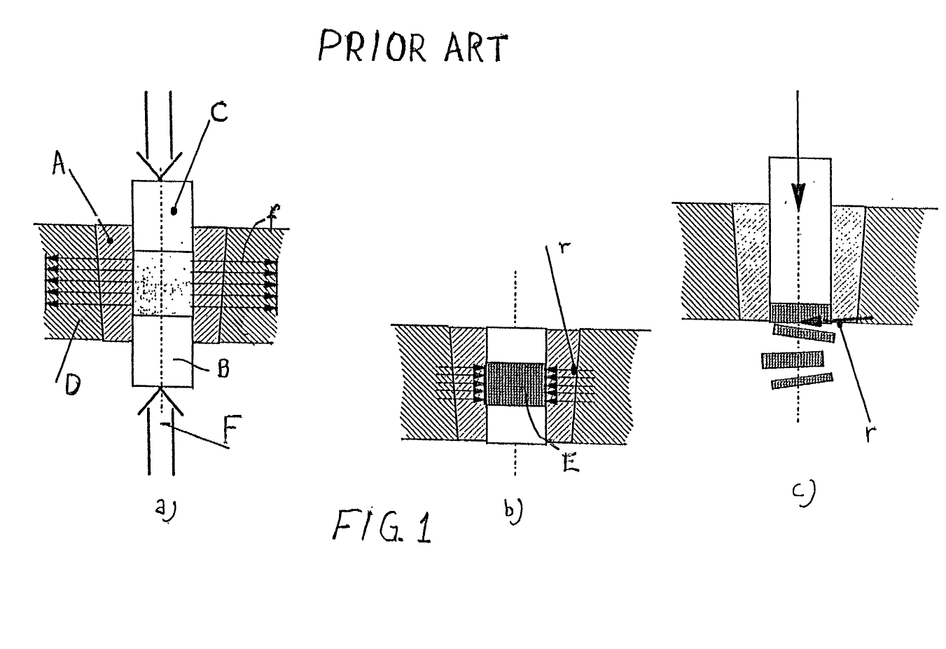

### DETAILED DESCRIPTION OF THE INVENTION

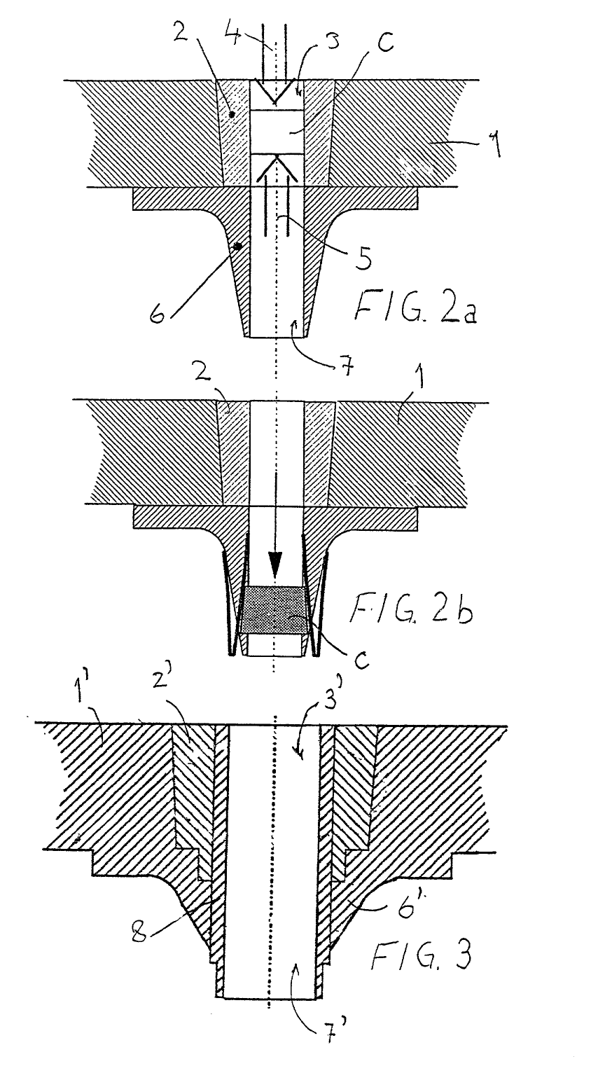

A first embodiment of a powder pressing device according to the present invention is schematically shown in FIGS. 2(a)-(b). This device includes a die 1 comprised of a main body having a conical inner space in which is disposed a tubular hard metal insert 2. The insert 2 has a central, cylindrical bore 3 defining the pressing region of the die. The device further includes an upper plunger schematically depicted in FIG. 2(a) by the arrow 4, and a lower plunger schematically represented in FIG. 2(a) by the arrow 5. The plungers 4, 5 are moveable into and out of the cylindrical bore or pressing region 3 by any suitable means in the same way as the plungers in known powder pressing devices. The components described above are similar to corresponding components in known powder pressing devices.

According to the first embodiment of the invention, the die 1 comprises a body 6 shaped like a funnel that is fastened to the under-side of the main body of the die in a suitable way. For example the funnel shaped body 6 can be bolted to the main body of the die. The body 6 has a bore 7 defining the ejecting region of the die. The bore 7 has the same cross-sectional shape and diameter as the bore 3 of the insert 2 defining the pressing region. The body 6 is fastened to the main body of the die so that the bores 3 and 7 are in alignment with each other. As is evident from FIGS. 2(a) and 2(b), the wall thickness of the funnel-shaped body 6 gradually decreases in the downward direction (i.e., in a direction away from the main body of the die).

The operation and functioning of the pressing device according to the present invention is as follows. The lower plunger is inserted into the bore 7 and is moved into the bore 3 to the position indicated by the point of the arrow 5 in FIG. 2(a). Thereafter, the powder to be compacted is filled into the bore 3 and the compacting operation is performed by pressing the upper plunger 4 into the bore 3 to a predetermined depth. In the illustration in FIG. 2(a), the pressing operation has just been performed and a compact C has been accomplished or achieved.

Thereafter, the lower plunger 5 is withdrawn from the bores 3 and 7, and the upper plunger 4 is moved downwards in order to eject the compact C from the device. When the compact C reaches the body 6, it is allowed to expand slightly in the radial direction, thereby reducing or relieving some of its residual tension. The stiffness of the body 6 gradually decreases in the downward direction due to the decreasing wall thickness of the body 6. This allows the compact C to expand further and gradually release a considerable amount of the residual tension. The length of the body 6 and its wall thickness are chosen so that the residual tension in the compact C has been reduced to such an extent that the shear stresses in the compact C when the compact C passes the lower end of bore 7 are sufficiently small that the compact will not be damaged in the same manner as described above in connection with other known powder pressing devices.

In the embodiment described with reference to FIGS. 2(a) and 2(b), the funnel shaped body 6 is a body that is separate from the main body of the die 1. It is of course also possible to make the body 6 an integral part of the main body of the die 1.

In FIG. 3, a second preferred embodiment of the inventive device is schematically shown. The embodiment depicted in FIG. 3 differs from the embodiment shown in FIGS. 2(a) and 2(b) in that a tube 8 of hard metal extends in the bores 3′ and 7′. The components in the FIG. 3 embodiment which correspond to similar components in the embodiment shown in FIGS. 2(a) and 2(b) are identified by the same reference numerals, but with the addition of a prime designation. The upper and lower plungers are not shown in FIG. 3 for the sake of simplicity, although it is to be understood that upper and lower plungers similar to those described above are employed in the FIG. 3 embodiment.

The tube 8 is press-fitted against the inner walls of the hard metal insert 2′ and the funnel shaped body 6′. By virtue of the tube 8, a smooth transition from the pressing region to the ejecting region is provided or ensured for a compact produced in the pressing region.

The stiffness of the pressing device is constituted by the combination of the Young's modulus and the thickness of the walls of the parts constituting the pressing device. Because the Young's modulus for the material used in the dies 1, 1′ is less than the Young's modulus for the hard metal insert 2, 2′, the stiffness of the device will have an abrupt change at the lower end of the metal insert 2 in the embodiment according to FIGS. 2(a)-(b), thereby leading to an abrupt change of expansion in a compact passing from the pressing region to the ejecting region of the device. In order to reduce the magnitude of the shear stresses created by the expansion of the compact in the transition area between the hard metal insert 2 and the funnel shaped body 6, the funnel body 6 can be provided with a rather thick wall in the transition area. By the provision of the hard metal tube 8 in the embodiment according to FIG. 3, it is possible to reduce the change in stiffness of the device in the transition area to a relatively very small amount, which is important because the residual tension in the compact is at a maximum in the transition area. The tube 8 is preferably made of the same hard metal as the hard metal insert 2′. As shown in FIG. 3, the funnel shaped body 6′ is integrally formed with the die 1′ or the main body of the die 1′.

The tube 8 preferably extends outside the lower end of the funnel shaped body 6′ and the wall thickness of the tube 8 is preferably reduced in the end portion. In the embodiment shown in FIG. 3, the change in the wall thickness of the end portion of the tube 8 is abrupt. However, it is of course possible to configure the tube 8 to possess a gradually decreasing wall thickness in the end portion of the tube 8.

In the drawing figures, the powder pressing device has been shown with the ejecting region being positioned downwards of or below the pressing region. It is of course also possible to place the ejecting region upwards of or above the pressing region so that the ejection is actuated by the lower plunger.

When a hard metal tube 8 extends through the thickness of the die as in the embodiment shown in FIG. 3, it is possible and sometimes preferable to make the insert 2′ of steel instead of hard metal. If the same steel as for the rest of the die is used for the insert 2′, it is even possible to make the insert integral with the rest of the die.

In the embodiments of the powder pressing device described above, the ejecting region of the device possesses an inlet proximal to the pressing region and an outlet distal from the pressing region. Also, the dimension of the die 1, 1′ gradually decreases in the ejecting region of the die in a direction from the inlet to the outlet.

The above-described embodiments can of course be modified without departing from the scope of the invention. For example, the metal tube can have a gradually decreasing wall thickness in the ejecting region of the device instead of having the same wall thickness to the end portion of the tube as shown in FIG. 3. Furthermore, other materials can be used for the die and for the insert and tube of hard metal. The hard metal tube need not be made of the same material as the insert, even though this may be preferred.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A powder pressing device comprising a die having an inner space providing a pressing region in which powder pressing takes place, and an upper plunger and lower plunger movable into and out of the inner space of the die, the die having an ejecting region possessing an inlet proximal to the pressing region and an outlet distal from the pressing region, and the dimension of the die gradually decreasing in the ejecting region of the die in a direction from the inlet to the outlet.

2. The powder pressing device according to claim 1, wherein the ejecting region of the die has a funnel shape.

3. The powder pressing device according to claim 2, including a tubular metal insert positioned in the die, the pressing region being located in the insert, and a metal tube extending through the pressing and ejecting regions of the die, said metal tube being press-fitted to an inner wall of the metal insert in the pressing region and to an inner wall of the die in the ejecting region.

4. The powder pressing device according to claim 3, wherein the metal tube extends beyond the outlet end of the ejecting region, the metal tube having a wall, an end portion of the wall of the metal tube having a decreased thickness.

5. The powder pressing device according to claim 2, including a tubular insert disposed in the pressing region of the die and press-fitted into the inner space of the die in the pressing region.

6. The powder pressing device according to claim 1, including a tubular metal insert positioned in the die, the pressing region being located in the metal insert, and a metal tube extending through the pressing and ejecting regions of the die, said metal tube being press-fitted to an inner wall of the metal insert in the pressing region and to an inner wall of the die in the ejecting region.

7. The powder pressing device according to claim 6, wherein the metal tube extends beyond an end of the die at the outlet of the ejecting region, the metal tube having a wall, an end portion of the wall of the metal tube having a decreased thickness.

8. The powder pressing device according to claim 1, including a metal tube extending through the pressing and ejecting regions of the die, the metal tube extending beyond an end of the die at the outlet of the ejecting region.

9. The powder pressing device according to claim 8, wherein the metal tube has a wall, an end portion of the wall of the metal tube having a reduced thickness relative to a portion of the wall of the tube adjacent the end portion.

10. A powder pressing device comprising a die having an inner space, a metal insert positioned in the inner space of the die and having a bore defining a pressing region in which powder pressing takes place, an upper plunger movable into and out of the inner space, a lower plunger movable into and out of the inner space, a tubular body provided at one end of the pressing region and having an interior defining an ejecting region, an inlet of the ejecting region being located proximal the pressing region and an outlet of the ejecting region being located distal from the pressing region, the body having a wall which possesses a thickness adjacent the outlet that is less than the thickness of the wall adjacent the inlet.

11. The powder pressing device according to claim 10, wherein the tubular body is funnel shaped.

12. The powder pressing device according to claim 11, including a metal tube extending through the pressing and ejecting regions, the metal tube being press-fitted to an inner wall of the metal insert in the pressing region and to an inner wall of the tubular body in the ejecting region.

13. The powder pressing device according to claim 12, wherein the metal tube extends beyond and end of the tubular body at the outlet of the ejecting region, the metal tube having a wall, an end portion of the wall of the metal tube having a decreased thickness.

14. The powder pressing device according to claim 10, including a metal tube extending through the pressing and ejecting regions, the metal tube extending beyond an end of the tubular body at the outlet of the ejecting region, the metal tube having a wall, an end portion of the wall of the metal tube which extends beyond the end of the tubular body having a decreased thickness.

15. The powder pressing device according to claim 10, wherein the thickness of the wall of the tubular body is gradually reduced.

16. The powder pressing device according to claim 10, wherein the tubular body is separate from and connected to the die.

17. The powder pressing device according to claim 10, wherein the tubular body is integrally formed with the die.

18. A powder pressing device comprising a die having an inner space in which is defined a pressing region that receives powder for powder pressing to produce a compact, an upper plunger movable into and out of the inner space and a lower plunger movable into and out of the inner space to powder press the powder and form the compact, the die including a tubular body forming an ejecting region having an inlet proximal to the pressing region and an outlet distal from the pressing region, the tubular body having a stiffness that gradually decreases in the direction towards the outlet of the ejecting region to allow the compact to gradually release its residual tension during ejection of the compact.

19. The powder pressing device according to claim 18, including a metal tube extending through the pressing and ejecting regions, the metal tube extending beyond an end of the tubular body.

20. The powder pressing device according to claim 18, wherein a thickness of the tubular body becomes gradually reduced towards the outlet of the ejecting region.
